(19) United States
(12) Patent Application Publication
(10) Pub. No.: US 2014/0351156 A1
(43) Pub. Date: Nov. 27, 2014

(54) METHOD AND SYSTEM OF PERSONAL ASSESSMENT AND PROFILING

(71) Applicant: mySOAP PH Limited, Hong Kong (HK)

(72) Inventor: PHILIPPE ORBAN, Hong Kong (HK)

(73) Assignee: mySOAP PH Limited, Hong Kong (HK)

(21) Appl. No.: 14/287,073

(22) Filed: May 26, 2014

Related U.S. Application Data
(60) Provisional application No. 61/827,533, filed on May 24, 2013.

(51) Int. Cl. G06Q 10/10

(52) U.S. Cl. CPC G06Q 10/1053
USPC 705/321

(57) ABSTRACT

One aspect of the present invention is a search engine that returns as results a list of job-seekers who meet specific criteria related to the results of professionally scored assessment profiles including personality, cognitive ability and skills aptitude. Coupled with the ability to score and rank the results of the assessment profiles, it facilitates the research on job-seekers prior to interviews. The present invention provides a method for assessing and profiling personal attributes, comprising: generating one or more personal assessment tests; generating one or more test results from the personal assessment tests taken; validating the test results; generating one or more personal profiles of the user, the personal profiles comprising the test results, and other personal attributes; allowing a user to publish whole or one or more portions of the personal profiles; and ranking a plurality of users using the test results of personal assessment tests taken by the users.

### CLAIM FOR DOMESTIC PRIORITY

This application claims priority under 35 U.S.C. §119 to the U.S. Provisional Patent Application No. 61/827,533, filed May 24, 2013, the disclosure of which is Many businesses utilize incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many businesses utilize standardized assessment profiling or tests to determine the aptitude and attitude of prospective employees in the hiring/contracting process. Currently this assessment is done after an applicant or prospect is identified and is accepted for review for a position. This process requires considerable time and cost on the recruiter or prospective employer's part to receive the information they require to qualify the prospect for the next round of interviews or job offer.

### SUMMARY OF THE INVENTION

MySOAP is an acronym for My Standard Online Assessment Profile and is a concept designed for use by job recruiters and human resource professionals to facilitate the screening and placement of job seekers by reducing the time and cost currently required to complete those processes.

The innovation of MySOAP involves, through the development of strategic alliances with the providers of these assessments, the ability allow the candidates (at their cost and on their time) to complete personality, cognitive and aptitude assessment batteries prior to applying for specific positions and to make their results available to, via their online profile and a search engine connected to the platform, recruiters for pre-qualification rather than completing the batteries on-demand for specific positions with specific companies. This will result in a dramatic reduction in the time and cost associated with identifying and screening potential employees for positions.

The concept aims to add value for specific market segments and was originally conceived to be used in the field of assessments, career development or advancement and recruiting.

One of the primary innovations of the MySOAP concept is a search engine that returns as results a list of job-seekers who meet specific criteria related to the results of professionally scored assessment profiles including, but not limited to, personality, cognitive ability and skills aptitude.

The novelty of the concept is extended with the ability to allow the scored results of the assessment profiles to be connected with internet profiles to facilitate the recruiter's research of job-seekers prior to approaching them for interview thus providing a highly expedited and cost efficient approach to job recruitment.

The secured exchange of information between the testing companies and the search engine ensures the maintenance of privacy and integrity of the testing data; although the job seeker can decide what information to allow to be searched, they cannot alter the results of the assessments.

The followings are the short-listed aspects that define the concept of mySOAP:
1. Profile page with the ability to customize
2. A user's redefined online presence
3. Centrally stored information
4. Validation of results (mySOAP)
5. Authentication of details (third party application uploads)
6. User's market (user is in control)
7. Push functionality—interaction with other websites
8. Broadcast/publish options—use the information to reach out in specific instances
9. Mirrors/ranking—the user can ‘rank’ himself compared to a variety of standards/target/median

### BRIEF DESCRIPTION OF THE DRAWINGS

Embodiments of the invention are described in more detail hereinafter with reference to the drawings, in which

FIG. 1 is a functional block diagram of MySOAP; and

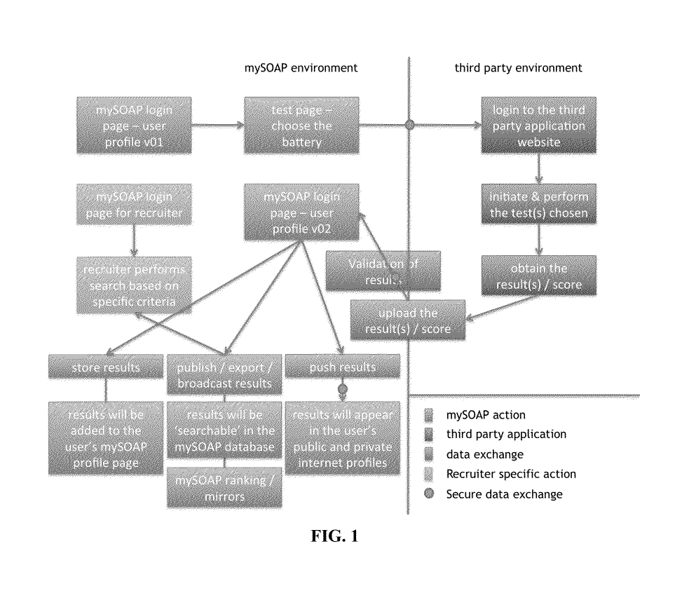

FIG. 2 is a system block diagram of MySOAP.

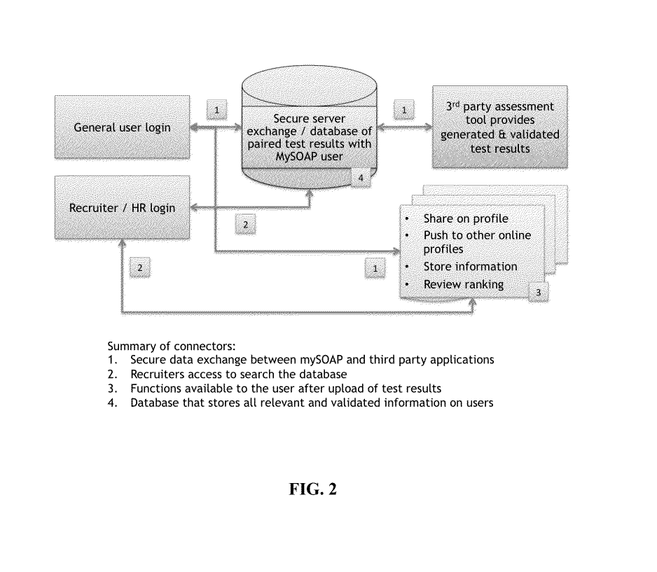

### DETAILED DESCRIPTION

### 1—The ‘About Me’ Driven by the User—The New Profile

The profile will be more user-defined/more customized. The profile will contain different aspects of the user's persona. The profile can function as a central storage point for imported profile information.

The user profile will contain different aspects of a person compared to regular social media sites and will allow the use of third party applications to pre-load profile details. Directly linked to part 3 of the novelties (validated results), users will show a different part of their personality on-line.

The complete profile page will have details such as test results, pre-loaded results from website queries (job positions, personal interests), uploaded results from other applications (IQ-test, . . . ) and so on.

A secure linkage between the providers of assessment scoring and a company engaged in the service of internet profiles that enables the connection of accredited results to an individual's online profile for the specific purpose of inclusion in search engine for recruiters and human resources professionals that returns as results a list of prospects who meet specific criteria related to the results of their professionally scored assessment profiles including, but not limited to, personality, cognitive ability and skills aptitude.

What is the ‘about me’?
1. The user profile will contain different aspects of a person compared to regular social media sites
2. The user will have access to validated results and be able to publish these (see part 3)
3. The user will be able to maintain validated data at a centralized storage location (the profile page)
4. MySOAP (assessment test) results will constitute the main part
5. Space is available for third party applications to pre-load profile details (myIQ, myEQ, mySAT)
6. The overall one page profile will be private with three main functions:
   a. Main function—maintain validated profile information that adds value to the user (career, consolidated details)
   b. Disclose function—allow other users to access data (e.g. related to a specific query or use)
   c. Push function—allows profile and profile changes to be ‘pushed’ to other applications

### 2—The Export Function Allowing Connectivity to Social Media

Where the profile page will host different aspects of the user's personality/identity, the information stored/gathered will not only be available on the mySOAP profile page but will also be able to be pushed into other social media platforms

By completing online tests, the user will be enabled to publish results as well as his profile through a variety of means. Push means that whatever changes and needs to be broadcasted out of the mySOAP profile will be pushed into other applications based on the interaction level the user has defined.

One can export, meaning publish and connect to:
1. Publish on the profile page with visibility levels (what am I willing to disclose?)
2. Blog pages where the ‘about me’ page will be pre-loaded with our validated results
3. Export to and interact with LinkedIn
4. Export to and interact with job-sites
5. Show off on Facebook

The user will not be allowed to dilute the results. Validation will restrict the possibility for users to ‘amend’ what they publish/broadcast.

### 3—Validated Results are Added to the User's Profile

The user profile will mainly consist of validated/authenticated information

The user's profile does not only consist of user-completed details such as name, profile picture, goals and aspirations but mainly includes results that are validated through completion of the available tests in mySOAP. These results are maintained at a central point.

The profile is thus loaded with validated (mySOAP) as well as pre-authenticated (third party) information.

3.1—Validated<mySOAP:

Information will come from the mySOAP environment (primary functions). The user will choose which tests/applications he is interested in and what he will display on the profile page. Next to displaying, the user will also control the visibility of the results.

These tests can be:
1. General personality profile tests indicating strengths and weaknesses
2. Knowledge testing
3. Personal awareness testing
4. Capacity testing
5. Full competency profile test for a specific position

### 3.2—Authenticated<Third Party Applications

Authenticated information comes from third party uploads into our system other than what exists through mySOAP (for instance IQ testing, Language proficiency, Logical reasoning and so on).

The final aim is to become the central storage system for authenticated information on a profile level. Whether this information comes from other applications that provide ‘authentic’ or validated details (IQ-testing where the user cannot control the published result/score) up to the upload of university degrees/SAT scores, GMAT, GRE and so on, the system will become the most valuable online database of a person's persona.

Going to a job interview, the user will merely login to his profile on mySOAP to have access to all the information required that can be retrieved for the specific purpose of showing his education, test scores, personality and so on. If not already published to the recruiter (the future employer or a recruitment agency), he will be able to get the information that is centrally stored in a few minutes, take it along via a mobile app or share it with the person/party organizing the job interview via the mySOAP profile page.

4—Power is with the ‘Seller’/the User Choosing to ‘Publish’:

The rules of the game change! The user takes control. The user has the option to disclose none, part or all the details and the user also decides who to disclose to or where to ‘publish’. We generate an additional layer of information that drives a user's online value/presence.

Upon completion of the tests—either under mySOAP or third party applications—the user may choose to publish or export these results or his completed profile.

Where under a normal scenario the user would only complete personality tests or competency assessments in specific circumstances (higher paid job opening, specific internal mobility, government functions), the user in mySOAP has the choice to add these results to other media. The user will thus pro-actively enhance his online presence by adding more information.

The user will gather information on (amongst others and not limited to):
1. His personality profile;
2. The potential career development;
3. How he fits into specific roles;
4. How he functions;
5. What his learning style might be;
6. How he measures up against others;

The possibilities are endless—the user can generate a complete new online presence and decide on what information is suitable for what purpose. The information that will be disclosed depends on whether the user interacts with LinkedIn, a job seekers website, Facebook and so on.

The user is in control and takes his career into his own hands in a more organized and pro-active manner. It will give the user credibility and reduce the lead-time to match his abilities and persona to the chosen career path or job opportunity. From the recruitment side, the recruiter will (if allowed to see the details) also have a significantly better position to filter his search results in the potential candidate database.

### 5—Universally Applicable Allowing Ranking and Minimizing Variances

By making mySOAP globally available, we level the playing field and allow users to rank themselves with other users in a variety of ways.

The tests will not only apply in specific circumstances when asked for by the future employer, but the user—who is in charge—will have validated results as part of his online presence, ready for whenever he is asked to provide these details. The user can pro-actively complete tests. The tests available on mySOAP would only be limited in type to those which can be delivered via electronic means within the limitations of the mySOAP platform, as it evolves.

The databases used will accumulate results and allow ranking. The user will be allowed to ask for ‘mySOAP mirrors’, which are comparisons between the user's own results and results from other users of the site.

Main applications of these mirrors are:
1. Where am I at this point in my career?
2. What kind of a person am I in my current role?
3. I have this profile, so how do I compare in
   a. The overall user group
   b. A specific test
   c. A specific group
   d. A specific industry
   e. A specific job position
   f. And so on (to be further developed)
4. How does the typical profile of x look like?

mySOAP will offer career-coaching tools. The results gathered in the user profile will allow the user to not only compare his results but also get an idea of where he is at a certain point in his career. By allowing ranking and comparison, mySOAP also facilitates a better match between the user and the job openings he is aiming for.

### 6—Ability to Process Psychometric Tests and Present the Results in a Structured Form to Multiple External APIs (Application Programming Interfaces)

Upon completion of the tests and based on user selection and approval data can be presented in multiple structured forms to external programs.

General Application of mySOAP

The goal of mySOAP is to share details of your personality with other users/other media. The use of mySOAP will result in building a profile on the mySOAP website.

The Added Value of mySOAP

In aiming for the additional layer, mySOAP will offer the possibility to provide others with insight into the user's personality and competencies. Rather than just stating these, the attributes will be screened through a variety of available tests.

The more information is added to the profile page, the more valuable the potential ‘export’ of the profile becomes. The user will redefine his online persona/presence. The primary user will also be able to ‘open’ his profile or parts of his profile by clicking the boxes that indicate which part will end up in queries on the website or will be displayed through push/publish functions.

The combination of details on the profile page will make the query element where the primary users has control, very valuable and will allow better targeting of profiles or job positions.

### User Value Addition in Relation to Job Hunting/Recruitment

### Primary Goal—Value Addition to the Job Seeker

By the completion of an online assessment, or assessments, that would be standard for their field of expertise, job seekers would be able to
Get an insight into their strengths and weaknesses/their personality
Build a profile showcasing their capabilities/how they measure up
Better define a specific career path and find out how they function in certain roles
Enable recruiting entities to target them much faster and more directly

In effect job seekers will be saying here I am, this is me and I meet your requirements. mySOAP will thus—as stated above—redefine the online presence of the user. Different information will be broadcasted and depending on the user, different information will be used for different purposes. The information that is gathered and stored under the mySOAP profile will be the backbone.

The vast amount of detail that can be included in the profile will urge the primary user to choose what to display on his profile page to other users or third party applications. The user can opt to publish or display (not limited to):
His full profile and details
   Preloaded data (assessment results)
   Uploaded data (third party applications)
   Resume, interests and other details
   Including ‘push’ function (uploads information to all other media)
The full profile without ‘push’ function
His full profile without details (values without details)
His basic profile (only personal details)
His interests in showing up in query results
No details

Push, available for the user, will mean that information that is changed in mySOAP is automatically uploaded into other private/public profiles.

### Secondary Goal—Value Addition to the Recruiting Function

During the search phase of recruiting the ability to view an assessment score—even if generic, but ranked—provided by an objective third party will ensure that internal and external recruiters are able to much more rapidly locate and engage with the type of prospective employees that are most desirable to their organizations. Having a relatively high level of assurance that their scores will be in line with corporate requirements will increase efficiency. Time is money. Employers save time and money in the screening, ultimately finding people with a strong fit for the job. And job seekers get the benefit of rapid screening, helping them figure out where their “perfect job” may be.

The completion of the assessments which are in line with a particular user's vocation or specialization would allow them to show up first in the results of searchers utilizing the scoring criteria as a search parameter.

MySOAP further defined—the S, O, A and P

Why standard or generic?
It is easy to understand
It is easy to interpret/use/re-use
It refers to basic competencies (recognizable)
It will show validated result
It applies to a variety of people/profiles (universally applicable)
It will allow an insight into the mass (ranking/variances)

Why do people use the tool online?
Ease of use/current way people think/share information
Online is faster and provides instant access from wherever you can log in
People want to be visible on the ‘market’, it defines them
People like exposure and want to share success
They will have a choice to publish

Why do people use the tool to be assessed?
They want to profile themselves/be found/be recognized
It will enhance the online presence with additional (validated) information
They want to be recruited and evaluated
   Both internal—for your own reference
   As well as external—to be published
They want to know their strengths/weaknesses (understand)
They want to see how they measure up
They want to understand how ACs work (practice)

What profile? Why profile?
They want to know who they are
   Build their profile
   Receive recognition
   Have ‘career’ guidance (goals/strengths/ . . . )
They want to be seen as successful
It is the missing piece in social media
It has publish/export capacity
It has push capacity into other online profiles

### Functions

After completing the tests, the user profile will be updated in the mySOAP environment. Four main functions will become available that will determine the essential character of the application—being able to share an additional layer of your profile and become searchable.

### Function 1—See My

First and primary function will be the ability to see the results of the completed tests, to see how you rank in the overall mass of users that are using mySOAP.

The user has the option to customize and will build his own profile/his own value/his own persona on the web based on validated results/details.

### Function 2—Export/Publish

The function that will appeal to most users is the export/publish function. This is a major novelty in the use of personality/competency tests. Users will have the ability to choose to publish the results of the tests. The user will allow other users to see the results, become searchable in the database and open his profile to queries.

The export/publish function will allow the user to update his ‘about me’ page.

### Function 3—Ask For

Where the results of the tests will be objective, we aim to add a layer on top of that through the use of endorsements. The user will be able to have his published results endorsed by other mySOAP users. A competence/personal strength/ . . . will only be shown as endorsed if a certain number of users endorse it.

Both the objective result from the test as well as other users endorsing a strength or emphasizing a weakness will make sure the value of mySOAP goes further than current ACs/tests.

### Function 4—Print/Send/Push

Printing will just allow the user to print the result or save it as a pdf file. MySOAP will have the option to also print the results in the form of a certificate of completion—an official receipt of having taken the test in a pre-defined format that can also be displayed.

The sending function will provide the user with the option to send a copy of his results to pre-determined recipients. This is not to be confused with the export function.

The push function allows the user to activate the mySOAP profile as a ‘master’ profile for other applications and push profile data/profile changes into other online private/public profiles.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for assessing and profiling personal attributes, comprising:
generating one or more personal assessment tests by a central processing server, a client computing device, or a third party computing processing server;
generating one or more test results from the one or more personal assessment tests taken;
validating the one or more test results;
generating one or more personal profiles of the user, the one or more personal profiles comprising the one or more test results, and other personal attributes;
allowing a user to publish whole or one or more portions of the one or more personal profiles; and
ranking a plurality of users using one or more test results of personal assessment tests taken by the users.
